(19) United States
(12) Patent Application Publication
(10) Pub. No.: US 2026/0065849 A1
(43) Pub. Date: Mar. 5, 2026

(54) LIGHT EMITTING DISPLAY DEVICE

(71) Applicant: LG Display Co., Ltd., Seoul (KR)

(72) Inventors: Jun-Hee HAN, Paju-si (KR); Yoon-Seob JEONG, Paju-si (KR)

(73) Assignee: LG Display Co., Ltd., Seoul (KR)

(21) Appl. No.: 19/284,417

(22) Filed: Jul. 29, 2025

(30) Foreign Application Priority Data
Aug. 30, 2024 (KR) 10-2024-0117542

(51) Int. Cl. G09G 3/32

(52) U.S. Cl. CPC G09G 3/32; G09G 2300/0426; G09G 2330/10; G09G 2360/148

(57) ABSTRACT

A light emitting display device includes: a substrate including a display region in which a plurality of subpixels are arranged; a light emitting diode in a subpixel, among the plurality of subpixels, and including an anode electrode, a light emitting layer on the anode electrode, and a cathode electrode on the light emitting layer; a photoresistor in the subpixel and positioned below the light emitting diode; a sensing transistor having a drain electrode connected to the photoresistor and a gate electrode connected to a gate line; and a sensing line connected to a source electrode of the sensing transistor.

### CROSS REFERENCE TO RELATED APPLICATION

The present application claims the priority benefit of Korean Patent Application No. 10-2024-0117542, filed in the Republic of Korea on Aug. 30, 2024, which is hereby incorporated by reference in its entirety for all purposes as if fully set forth herein.

### BACKGROUND

### Field of the Disclosure

The present disclosure relates to a light emitting display device.

### Discussion of the Related Art

Recently, flat panel display devices with excellent characteristics, such as thinness, weight reduction, and low power consumption, have been widely developed and applied to various fields.

Among the flat panel display devices, light emitting display devices equipped with light emitting elements, such as light emitting diodes, are display devices that emit light when charges are injected into a light emitting layer formed between an anode and a cathode, and electrons and holes are paired and then extinguished.

The light emitting display device may have dark spots or bright spots for various reasons during or after manufacturing, and such the light emitting defects are generally detected through visual inspection. However, there are cases where the light emitting defects are not detected through visual inspection and are shipped, and in particular, the dark spots are not easily visible, making it difficult to detect the defects.

After a display device with unintentional light emitting defects is manufactured and shipped and delivered to a customer, it is difficult to identify information about a defective state of a product.

However, from the perspective of product development and quality improvement, defect information is very important, and information about the product status after delivery to a customer is necessary.

### SUMMARY

An advantage of the present disclosure is to provide a light emitting display device that can easily identify a lighting state of a light emitting diode and effectively detect a lighting emitting defect.

Additional features and advantages of the disclosure will be set forth in the description which follows, and in part will be apparent from the description, or may be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a light emitting display device includes: a substrate including a display region in which a plurality of subpixels are arranged; a light emitting diode in a subpixel, among the plurality of subpixels, and including an anode electrode, a light emitting layer on the anode electrode, and a cathode electrode on the light emitting layer; a photoresistor in the subpixel and positioned below the light emitting diode; a sensing transistor having a drain electrode connected to the photoresistor and a gate electrode connected to a gate line; and a sensing line connected to a source electrode of the sensing transistor.

In another aspect, a light emitting display device includes:. a substrate including a display region in which a plurality of subpixels are arranged; a plurality of light emitting diodes, each light emitting diode being disposed in a respective subpixel, among the plurality of subpixels, and including an anode electrode, a light emitting layer on the anode electrode, and a cathode electrode on the light emitting layer; a plurality of photoresistors, each photoresistor overlapping an emission region of the respective subpixel and positioned in an emission direction of a light emitting diode disposed in the respective subpixel; a sensing line receiving light sensing signals respectively generated by the plurality of photoresistors; and a plurality of sensing transistors each connecting a respective photoresistor among the plurality of photoresistors to the sensing line, wherein the light sensing signals for the plurality of subpixels are sequentially output to the sensing line in a unit of a row line through the plurality of sensing transistors.

In yet another aspect, a light emitting display device includes a display region in which a plurality of subpixels are arranged along a plurality of row lines and a plurality of column lines, each of the plurality of subpixels including: a first transistor; a light emitting diode; a driving transistor having a first electrode connected to a power line of high potential voltage, a second electrode connected to an anode electrode of the light emitting diode, and a gate electrode coupled to the first transistor; a second transistor coupled to the second electrode of the driving transistor; and a photoresistor connected to the power line of high potential voltage.

It is to be understood that both the foregoing general description and the following detailed description are by way of example and explanatory and are intended to provide further explanation of the disclosure as claimed.

### BRIEF DESCRIPTION OF THE DRAWINGS

The accompanying drawings, which are included to provide a further understanding of the present disclosure and are incorporated in and constitute a part of this specification, illustrate example embodiments of the disclosure and together with the description serve to explain various principles of the disclosure. In the drawings:

FIG. 1 is a view schematically illustrating a light emitting display device according to an example embodiment of the present disclosure;

FIG. 2 is a view schematically illustrating a circuit structure of a subpixel of a light emitting display device according to an example embodiment of the present disclosure;

FIG. 3 is a view illustrating a light sensing operation when a display panel is driven to emit light according to an example embodiment of the present disclosure;

FIG. 4 is a waveform view illustrating example gate signals and light sensing signals when a display panel of FIG. 3 is driven to emit light;

FIG. 5 is a view illustrating light sensing signals detected when subpixels arranged in a column line of a display panel do normal light emission according to an example embodiment of the present disclosure;

FIG. 6 is a view illustrating light sensing signals detected when one of subpixels arranged in a column line of a display panel has a dark spot defect according to an example embodiment of the present disclosure;

FIG. 7 is a view illustrating light sensing signals detected when one of subpixels arranged in a column line of a display panel has a bright spot defect according to an example embodiment of the present disclosure;

FIG. 8 is a plan view schematically illustrating subpixels of a light emitting display device according to an example embodiment of the present disclosure;

FIG. 9 is a cross-sectional view taken along a line IX-IX′ in FIG. 8;

FIG. 10 is a cross-sectional view taken along a line X-X′ in FIG. 8; and

FIG. 11 is a plan view schematically illustrating a case where a photoresistor of a display panel is formed in a maze structure according to an example embodiment of the present disclosure.

### DETAILED DESCRIPTION

Advantages and features of the present disclosure and methods of achieving them will be apparent with reference to the embodiments described below in detail with the accompanying drawings. However, the present disclosure is not limited to the embodiments disclosed below, but can be realized in a variety of different forms. The present disclosure is provided to fully inform the scope of the disclosure to those skilled in the art of the present disclosure, and the protected scope of the present disclosure may be defined by the scope of the claims and their equivalents.

The shapes, sizes, proportions, angles, numbers, and the like disclosed in the drawings for explaining the embodiments of the present disclosure are illustrative, and the present disclosure is not limited to the illustrated matters. The same reference numerals refer to the same components throughout the description.

Furthermore, in describing the present disclosure, where a detailed description of the related known technology may unnecessarily obscure the subject matter of the present disclosure, the detailed description thereof can be omitted. Where ‘comprising’, ‘including’, ‘having’, ‘consisting’, and the like are used in this disclosure, other parts can be added unless a more limiting term like ‘only’ is used. Where a component is expressed in the singular, cases including the plural are included unless specific statement is described.

In interpreting the components, even if there is no separate explicit description, they should be interpreted as including a margin range.

In the case of a description of a positional relationship, for example, where the positional relationship of two parts is described as ‘on’, ‘over’, ‘above’, ‘below’, ‘beside’, ‘under’, and the like, one or more other parts can be positioned between such two parts unless a more limiting term like ‘right’ or ‘directly’ is used.

In the case of a description of a temporal relationship, for example, when a temporal precedence is described as ‘after’, ‘following’, ‘before’, and the like, cases that are not continuous can be included unless a more limiting term like ‘directly’ or ‘immediately’ is used.

In describing components of the present disclosure, terms such as first, second and the like can be used. These terms are only for referring to the components separately from other components, and an essence, order, order, or number of the components is not limited by the terms.

Respective features of various embodiments of the present disclosure can be partially or wholly connected to or combined with each other and can be technically interlocked and driven variously, and respective embodiments can be independently implemented from each other or can be implemented together with a related relationship.

Hereinafter, example embodiments of the present disclosure are described in detail with reference to the drawings. In the following example embodiments, the same and like reference numerals are assigned to the same and like components, and detailed descriptions thereof may be omitted.

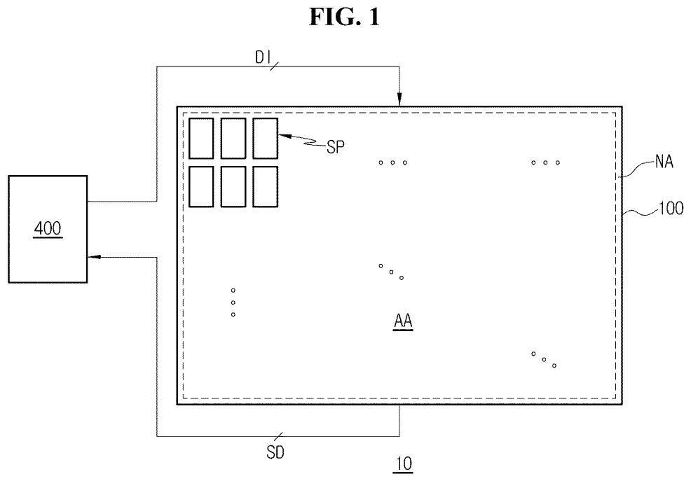

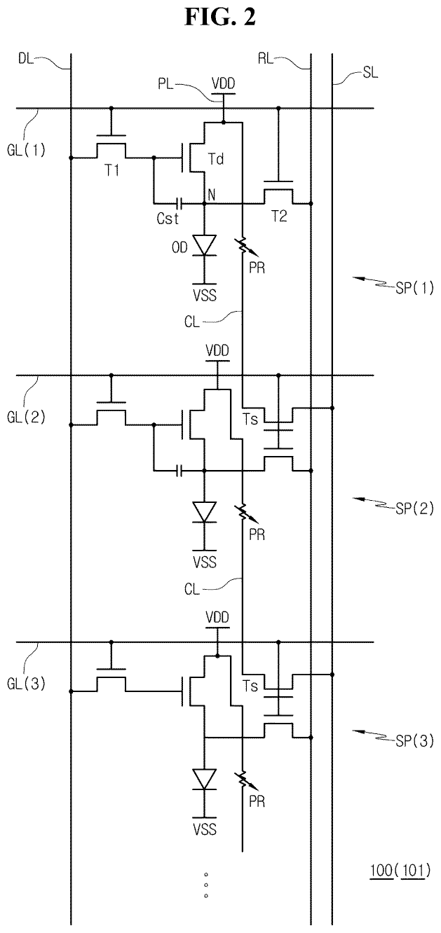

FIG. 1 is a view schematically illustrating a light emitting display device according to an example embodiment of the present disclosure. FIG. 2 is a view schematically illustrating a circuit structure of a subpixel of a light emitting display device according to an example embodiment of the present disclosure.

Prior to a detailed description, the light emitting display device 10 according to example embodiments of the present disclosure can include all types of display devices that include light emitting diodes OD, which are self-luminous elements, to display images.

In this example embodiment, for convenience of explanations, an organic light emitting display device is used as an example of the light emitting display device 10.

As shown in FIGS. 1 and 2, the light emitting display device 10 (or its light emitting display panel) of the present embodiment can include a display panel (or light emitting display panel) 100 in which a display region AA for displaying an image and a non-display region NA arranged around the display region AA are defined, and a panel driving circuit 400.

In the display region AA of the display panel 100, a plurality of subpixels SP arranged along a plurality of row lines (or horizontal lines) and a plurality of column lines (or vertical lines) can be formed on a substrate 101.

In addition, a plurality of gate lines GL extending along the row direction (or horizontal direction or first direction) and a plurality of data lines DL extending along the column direction (or vertical direction or second direction) can be formed on the substrate 101.

During a normal operation to display an image, the plurality of gate lines GL can be sequentially scanned in a unit of a row line (or a horizontal period) to be applied with gate signals. In addition, during a scan period when the gate line GL is applied with the corresponding gate signal, data signals DI for displaying an image can be applied to the respective data lines DL and input to the respective subpixels SP.

Such the gate signals and data signals DI can be output from the panel driving circuit 400 and be provided to the display panel 100.

Meanwhile, a power line PL that transmits a high potential voltage (or a first driving voltage) VDD to the subpixel SP can be formed on the substrate 101. A reference line RL that transmits a sensing voltage for compensation of characteristics of a driving transistor Td, for example, threshold voltage and/or mobility compensation, and also provides a reference voltage to the subpixel SP can be formed on the substrate 101.

Furthermore, in this embodiment, a plurality of sensing lines (or light emitting sensing lines) SL extending along the column direction can be formed on the substrate 101. The sensing line SL can, for example, extend in parallel with the data line DL in each column line.

As described below, the sensing line SL can transmit a light sensing signal (or light emitting sensing signal) SD generated by sensing light generated from the subpixel SP to detect a light emitting state (or lighting state) when emitting light from the light emitting diode OD arranged in each subpixel SP of the corresponding column line. The light sensing signal SD can be provided to the panel driving circuit 400.

In this regard, each subpixel SP can be equipped with a photoresistor PR which is a photoelectric element that receives light generated from the corresponding light emitting diode OD and generates a light sensing signal SD of a size (or magnitude) corresponding to an amount of the received light (or an amount of incident light).

The photoresistor PR can be, for example, a variable resistor which is formed using a photoelectric material and whose resistance value varies by photoelectric effect. This photoresistor PR can have the characteristic that a resistance value decreases when the amount of the received light increases and increases when the amount of the received light decreases.

Accordingly, the resistance value of the photoresistor PR can change depending on the light emitting state of the corresponding subpixel SP, and the light sensing signal SD, which is a current flowing through the photoresistor PR, can change according to the change in resistance value.

As a result, when the light emitting diode OD normally emits light, a current of a corresponding normal light emitting state can flow through the photoresistor PR and be generated as the light sensing signal SD. When the light emitting diode OD abnormally emits light darker than it normally emits light (or the light emitting diode OD does low light emission), a low current in a corresponding low light emitting state can flow through the photoresistor PR and be generated as the light sensing signal SD. When the light emitting diode OD abnormally emits light brighter than it normally emits light (or the light emitting diode OD does high light emission), a high current in a corresponding high light emitting state can flow through the photoresistor PR and be generated as the light sensing signal SD. When the subpixel SP is defective in a dark spot and is practically in a non-light emitting state, no current may flow through the photoresistor PR, and thus the light sensing signal SD can be practically in an off-level state.

As above, the light sensing signal SD can be generated and output by sensing the light emitting state of the light emitting diode OD through the photoresistor PR provided in the subpixel SP, and such the light sensing signal SD can be applied to the sensing line SL.

Accordingly, for example, the light sensing signal SD generated from each of the subpixels SP arranged in the corresponding column line can be sequentially (or continuously) output to the sensing line SL in a unit of a row line.

In other words, in each column line, the light sensing signal SD that senses the light emitting state of the subpixel SP per row line can be sequentially output to the sensing line SL, and as a result, the light sensing signals SD generated from all row lines of the corresponding column line can be sequentially applied to the sensing line SL and provided to the panel driving circuit 400.

In this case, for example, the panel driving circuit 400 can use the input light sensing signals SD to check the light emitting states of the subpixels SP and identify and detect the subpixel SP with the light emitting defect.

As described above, the light sensing using the photoresistor PR to check the light emitting state of the subpixel SP and detect the light emitting defect of the subpixel SP is described in more detail below.

The plurality of subpixels SP arranged in the display panel 100 can include subpixels SP of different colors that constitute a pixel which is a unit for displaying a color image. In this regard, the plurality of subpixels SP can include subpixels SP that respectively display first, second, and third colors, for example, red, green, and blue subpixels SP, but not limited thereto.

Each subpixel SP can include the light emitting diode OD, and a plurality of transistors and at least one capacitor for driving the light emitting diode OD.

Meanwhile, in this embodiment, for convenience of explanation, a 3T1C structure in which the subpixel SP is provided with three transistors T1, T2 and Td and one capacitor Cst as illustrated in FIG. 2 is taken as an example.

The subpixel SP is described with reference to FIG. 2. Meanwhile, for convenience of explanations, FIG. 2 illustrates the subpixels SP arranged along one column line of the display panel 100. In addition, the subpixels (SP: SP(1), SP(2) and SP(3)) located in three consecutive row lines in the column line, for example, a first row line, a second row line, and a third row line are illustrated as an example.

In addition, in the description below terms source electrode and drain electrode of a transistor are used to separately refer to two electrodes connected to a semiconductor layer, and the terms can be used interchangeably in some cases.

The subpixel SP can include a first transistor T1 and a second transistor T2, which are switching transistors, a driving transistor Td, a storage capacitor Cst, and a light emitting diode OD. The first transistor T1 can be a data supply transistor, and the second transistor T2 can be a driving characteristic sensing transistor.

The first and second transistors T1 and T2, the driving transistor Td, and the storage capacitor Cst can constitute a pixel driving circuit for driving the light emitting diode OD in an image display operation. In other words, the first and second transistors T1 and T2, the driving transistor Td and the storage capacitor Cst can form a pixel driving circuit for performing normal driving to display an image through the light emitting display device 10.

Furthermore, in this embodiment, as mentioned above, the photoresistor PR that senses light generated from the light emitting diode OD in each subpixel SP and generates a light sensing signal SD, which is a current of a size corresponding to the amount of the received light, can be formed.

The photoresistor PR can be positioned in a light emission (or light output) direction of the light emitting diode OD to receive light generated from the light emitting diode OD. For example, when the light emitting diode OD is of a bottom emission type, the photoresistor PR can be located below the light emitting diode OD, and when the light emitting diode OD is of a top emission type, the photoresistor PR can be located on the light emitting diode OD. As described below, in this embodiment, the light emitting diode OD of the bottom emission type is taken as an example, and accordingly, the photoresistor PR can be formed below the light emitting diode OD. More specifically, the photoresistor PR can be disposed below the light emitting diode OD corresponding to (or overlapping with) an emission region of the subpixel SP.

The photoresistor PR can be formed of, for example, a photoelectric material and have a characteristic in which a resistance varies by a photoelectric effect. In this regard, for example, when the subpixel SP has a dark spot defect and thus is in a non-light emitting state due to a dark spot defect, the photoresistor PR changes to a very high resistance value, so that practically no current flows. When the subpixel SP is in a normal light emitting state, the photoresistor PR has a corresponding normal resistance value, so that normal current flows. When the subpixel SP has a bright spot defect and thus is in a high light emitting state, the photoresistor PR changes to a very low resistance value, so that a high current higher than the normal current flows.

As described above, in this embodiment, the photoresistor PR that can sense the light emitting state of the subpixel SP and generate the light sensing signal SD to determine whether it has a normal light emitting or an abnormal light emitting can be formed inside the subpixel SP.

In addition, a sensing transistor Ts, which is a switching transistor that is connected between the photoresistor PR of each subpixel SP and the sensing line SL and switches an output of the photoresistor PR on/off, can be formed.

The sensing transistor Ts can operate, for example, when the subpixel SP is normally driven to display an image.

The sensing transistor Ts can be driven, for example, so that its turn-on section (or scan section) can overlap with an emission section of the subpixel SP where the photoresistor PR connected to the sensing transistor Ts is located.

In this regard, in each column line, the sensing transistors Ts that are respectively connected to the subpixels SP arranged in the row lines of this column line can be arranged, and these sensing transistors Ts (and the first and second transistors T1 and T2) can be sequentially scan-driven in one direction, for example, from an upper row line to a lower row line. Accordingly, in each column line, the photoresistor PR and the sensing line SL can be connected sequentially in a unit of a row line.

Meanwhile, in this embodiment, the sensing transistor Ts can be disposed in the subpixel SP of a row line that is later (or lower) than a row line of the subpixel SP in which the photoresistor PR connected to the sensing transistor Ts is disposed. In other words, the sensing transistor Ts can be connected to the photoresistor PR disposed in the subpixel SP of a row line that is earlier (or upper) than a row line in which the sensing transistor Ts is disposed.

In this regard, as shown in FIG. 2, for example, the photoresistor PR disposed in the subpixel SP(1) of the first row line can be connected to the sensing transistor Ts disposed in the subpixel SP(2) of the second row line. Similarly, the photoresistor PR disposed in the subpixel SP(2) of the second row line can be connected to the sensing transistor Ts disposed in the subpixel SP(3) of the third row line. In this way, the photoresistor PR arranged in each row line can be connected to the sensing transistor Ts arranged in the next row line.

An electrical connection relationship of components arranged in the subpixel SP is described in more detail.

The first transistor T1 can be connected to the corresponding gate line GL and data line DL. In this regard, a drain electrode (or source electrode) of the first transistor T1 can be connected to the data line DL, and a gate electrode of the first transistor T1 can be connected to the gate line GL.

The driving transistor Td can have a gate electrode connected to a source electrode of the first transistor T1, a drain electrode (or source electrode) connected to the power line PL to receive the high potential voltage VDD, and a source electrode (or drain electrode) connected to an anode electrode of the light emitting diode OD.

The second transistor T2 can be connected to the corresponding gate line GL and reference line RL. In this regard, a drain electrode (or source electrode) of the second transistor T2 can be connected to the reference line RL, a gate electrode of the second transistor T2 can be connected to the gate line GL, and a source electrode (or drain electrode) of the second transistor T2 can be connected to a node N between the driving transistor Td and the light emitting diode OD. In other words, the source electrode of the second transistor T2 can be connected to the source electrode of the driving transistor Td and the anode electrode of the light emitting diode OD.

As such, in this embodiment, the case where the second transistor T2 and the first transistor T1 in the subpixel SP are connected to the same gate line GL and receive the same gate signal is taken as an example. As another example, the second transistor T2 can be configured to be connected to the gate line GL different from the gate line GL connected to the first transistor T1.

A cathode electrode of the light emitting diode OD can receive a low potential voltage (or second driving voltage) VSS. The low potential voltage VSS is a voltage of a lower potential than the high potential voltage VDD and can include a ground voltage.

The storage capacitor Cst can be connected between the gate electrode and the source electrode of the driving transistor Td.

In the case configured as above, in operating in a display mode for displaying an image, when a gate signal is applied through the gate line GL, the first transistor T1 can be turned on and the data signal DI can be input to the subpixel SP, so that the data signal DI can be applied to the gate electrode of the driving transistor Td. At this time, the second transistor T2 can be turned on and a reference voltage can be applied to the source electrode of the driving transistor Td. Accordingly, the data signal DI and the reference voltage can be applied to both electrodes of the storage capacitor Cst, so that the data signal DI can be stored in the storage capacitor Cst.

Then, when the gate signal is not applied to the gate line GL and is in an off state, the first and second transistors T1 and T2 can be turned off, the driving transistor Td can be turned on, and an emission current (or driving current) corresponding to the applied data signal DI can flow to the light emitting diode OD through the driving transistor Td. Accordingly, light corresponding to the emission current during the emission section can be generated and output from the light emitting diode OD.

Meanwhile, in operating in a compensation mode for compensating the driving transistor Td, a sensing data signal can be applied to the subpixel SP and a sensing voltage can be provided to the reference line RL through the second transistor T2. Based on the sensing voltage, the data signal DI for image display can be compensated, and the compensated data signal DI can be applied to the subpixel SP to compensate the driving transistor Td.

The photoresistor PR and the sensing transistor Ts for sensing the light emitting state of the subpixel SP are described.

The photoresistor PR can be configured to be connected, for example, between the power line PL and the sensing transistor Ts arranged in the subpixel (SP) of the next row line.

In this regard, the photoresistor PR can be connected to the power line PL at one end (or first end or input end) thereof and receive the high potential voltage VDD. The photoresistor PR can be connected to a drain electrode (or source electrode) of the sensing transistor Ts at the other end (or second end or output end) thereof.

In addition, the sensing transistor Ts can be configured to be connected, for example, between the photoresistor PR arranged in the subpixel SP of the previous row line and the sensing line SL.

In this regard, the sensing transistor Ts can have a source electrode (or drain electrode) connected to the sensing line SL.

In addition, a gate electrode of the sensing transistor Ts can be connected to, for example, the gate line GL arranged in the corresponding row line. As such, the sensing transistor Ts can be connected to the gate line GL which the first transistor T1 of the corresponding subpixel SP is connected to, and can receive the same gate signal as the first transistor T1.

As another example, the sensing transistor Ts can be configured to be connected to the gate line GL (or sensing gate line) different from the gate line which the first transistor T1 is connected to, and can receive a different gate signal.

When the sensing transistor Ts is connected to the gate line GL and driven, during a turn-on section of the sensing transistor Ts (i.e., a scan section of the gate line GL), the photoresistor PR of the subpixel SP of the previous row line connected to the sensing transistor Ts and the sensing line SL can be electrically connected through the sensing transistor Ts.

As such, in the state in which the photoresistor PR and the sensing line SL are connected through the sensing transistor Ts, the light sensing signal SD flowing through the photoresistor PR can be transmitted to the sensing line SL through the sensing transistor Ts.

For example, when the subpixel SP(1) of the first row line is scanned in the corresponding horizontal period and the gate signal is applied to the gate line GL(1) and the data signal DI is input, the light emitting diode OD can operate during the emission section of the first row line to generate light.

Accordingly, during the emission section of the first row line, light can be sensed by the photoresistor PR in the corresponding subpixel SP(1) to generate the light sensing signal SD.

Meanwhile, when the subpixel SP(2) of the second row line is scanned in the corresponding horizontal period and the gate signal is applied to the gate line GL(2), the sensing transistor Ts can be turned on. Accordingly, during the scan section of the second row line, the photoresistor PR of the subpixel SP(1) of the first row line and the sensing line SL, which are connected to the sensing transistor Ts, can be electrically connected to each other through the sensing transistor Ts.

As such, in the turn-on state of the sensing transistor Ts, the light sensing signal SD detected by the photoresistor PR of the subpixel SP(1) of the first row line can be output to the sensing line SL through the sensing transistor Ts.

Similarly, when the sensing transistor Ts of the third row line is turned on, the light sensing signal SD detected by the photoresistor PR of the subpixel SP(2) of the second row line can be output to the sensing line SL through the sensing transistor Ts.

As above, during the scan section of the row line where the sensing transistor Ts is disposed, the light sensing signal SD generated through the photoresistor PR of the subpixel SP of the previous row line can be output to the sensing line SL through the sensing transistor Ts.

Accordingly, when the row lines arranged in each column line are sequentially driven, the light sensing signals SD that sense the light emitting states of the subpixels SP in a unit of a row line can be sequentially output to the sensing line SL, so that the light sensing signals SD generated in the entire row lines arranged in each column line can be provided to the sensing line SL.

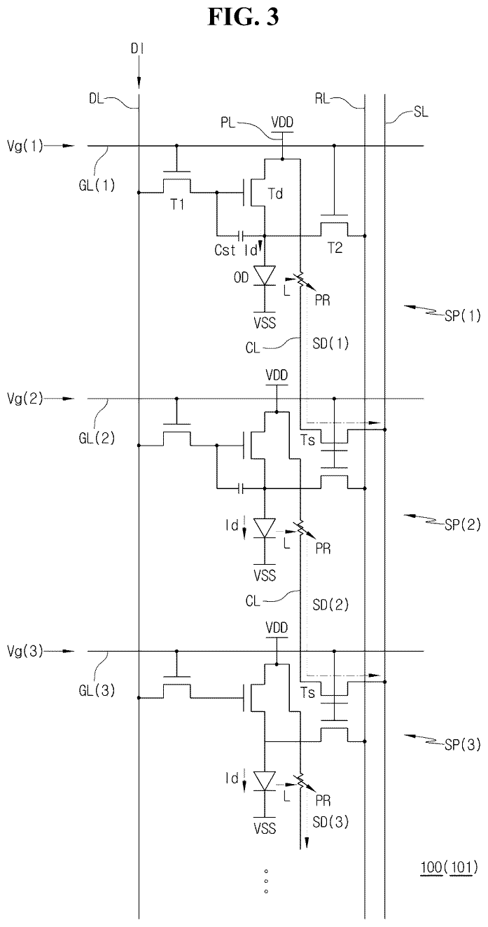

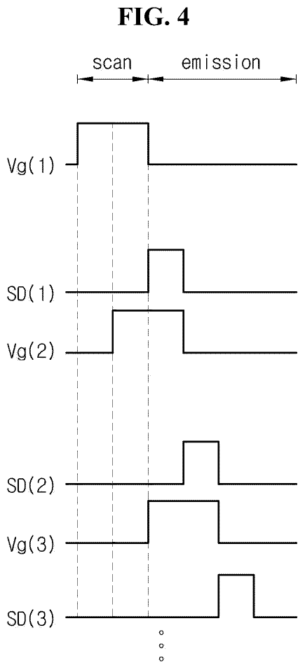

The light emission operation of the light emitting diode OD and the light sensing operation of the photoresistor PR and sensing transistor Ts is described in more detail with further reference to FIGS. 3 and 4. FIG. 3 is a view illustrating a light sensing operation when a display panel is driven to emit light according to an embodiment of the present disclosure, and FIG. 4 is a waveform view illustrating gate signals and light sensing signals when a display panel of FIG. 3 is driven to emit light.

Prior to a detailed description, in this embodiment, for convenience of explanations, the first to third row lines, and the gate signals (Vg: Vg(1), Vg(2), Vg(3)) driving the first to third row lines and the light sensing signals (SD: SD(1), SD(2), SD(3)) sensed from the first to third row lines are illustrated by way of example.

In addition, the case in which the gate signals Vg are sequentially applied to row lines and the turn-on sections of the gate signals Vg applied to the neighboring row lines overlap each other is illustrated by way of example. In other words, the case in which the turn-on section of the gate signal Vg of the current row line overlaps the turn-on section of the gate signal Vg of the next row line is illustrated by way of example.

As shown in FIGS. 3 and 4 along with FIGS. 1 and 2, the first row line is scanned, so that the first gate signal Vg(1) can be applied to the first gate line GL(1) during the horizontal period, and the corresponding data signal DI can be input to the subpixel SP(1). Accordingly, the data signal DI can be provided to the gate electrode of the driving transistor Td and stored in the storage capacitor Cst.

When the first gate signal Vg(1) becomes an off level, the driving transistor Td can be turned on during the emission section, and the emission current Id corresponding to the data signal DI can be generated and provided to the light emitting diode OD through the driving transistor Td, and accordingly, the light emitting diode OD can generate and output light L corresponding to the emission current Id.

Furthermore, when the light emitting diode OD emits the light L, the light L can be sensed by the photoresistor PR in the corresponding subpixel SP(1), and a corresponding light sensing signal SD, i.e., a first light sensing signal SD(1) can be generated.

Next, the second row line is scanned, so that the second gate signal Vg(2) can be applied to the second gate line GL(2) during the horizontal period, and the corresponding data signal DI can be input to the subpixel SP(2). Accordingly, the data signal DI can be provided to the gate electrode of the driving transistor Td and stored in the storage capacitor Cst.

When the second gate signal Vg(2) becomes an off level, the driving transistor Td can be turned on during the emission section, and the emission current Id corresponding to the data signal DI can be generated and provided to the light emitting diode OD through the driving transistor Td, and accordingly, the light emitting diode OD can generate and output light L corresponding to the emission current Id.

Furthermore, when the light emitting diode OD emits the light L, the light L can be sensed by the photoresistor PR in the corresponding subpixel SP(2), and a corresponding light sensing signal SD, i.e., a second light sensing signal SD(2) can be generated.

Meanwhile, during the scan section when the second gate signal Vg(2) is applied, the sensing transistor Ts disposed in the corresponding subpixel SP(2) can be turned on. As a result, through the turned-on sensing transistor Ts, the photoresistor PR of the subpixel SP(1) of the first row line connected to the sensing transistor Ts and the sensing line SL can be electrically connected.

Accordingly, the light sensing signal SD(1) generated by the photoresistor PR in the emission section of the subpixel SP(1) of the first row line can be output and applied to the sensing line SL through the sensing transistor Ts in the turn-on state disposed in the subpixel SP(2) of the second row line.

Next, the third row line is scanned, so that the third gate signal Vg(3) can be applied to the third gate line GL(3) during the horizontal period, and the corresponding data signal DI can be input to the subpixel SP(3). Accordingly, the data signal DI can be provided to the gate electrode of the driving transistor Td and stored in the storage capacitor Cst.

When the third gate signal Vg(3) becomes an off level, the driving transistor Td can be turned on during the emission section, and the emission current Id corresponding to the data signal DI can be generated and provided to the light emitting diode OD through the driving transistor Td, and accordingly, the light emitting diode OD can generate and output light L corresponding to the emission current Id.

Furthermore, when the light emitting diode OD emits the light L, the light L can be sensed by the photoresistor PR in the corresponding subpixel SP(3), and a corresponding light sensing signal SD, i.e., a third light sensing signal SD(3) can be generated.

Meanwhile, during the scan section when the third gate signal Vg(3) is applied, the sensing transistor Ts disposed in the corresponding subpixel SP(3) can be turned on. As a result, through the turned-on sensing transistor Ts, the photoresistor PR of the subpixel SP(2) of the second row line connected to the sensing transistor Ts and the sensing line SL can be electrically connected.

Accordingly, the light sensing signal SD(2) generated by the photoresistor PR in the emission section of the subpixel SP(2) of the second row line can be output and applied to the sensing line SL through the sensing transistor Ts in the turn-on state disposed in the subpixel SP(3) of the third row line.

Similarly to the above, the light sensing signal SD(3) generated by the photoresistor PR in the emission section of the subpixel SP(3) of the third row line can be output and applied to the sensing line SL through the sensing transistor Ts in the turn-on state disposed in the subpixel SP of a fourth row line.

In the above manner, when the row lines arranged in each column line are sequentially driven during one frame, the light sensing signals SD that sense the light emitting states of the subpixels SP in a unit of a row line can be sequentially output to the sensing line SL, so that the light sensing signals SD generated in all row lines arranged in the column line can be provided to the sensing line SL.

By checking the states of the light sensing signals SD output to the sensing line SL in the above manner, the light emitting state of each subpixel SP can be checked, and the subpixel SP with a light emitting defect can be identified and detected.

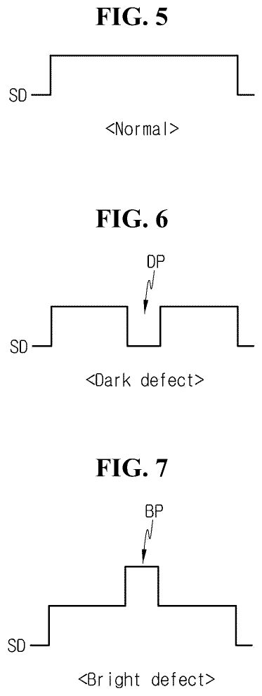

This is described with further reference to FIGS. 5 to 7. FIG. 5 is a view illustrating light sensing signals detected when subpixels arranged in a column line of a display panel do normal light emission according to an example embodiment of the present disclosure. FIG. 6 is a view illustrating light sensing signals detected when one of subpixels arranged in a column line of a display panel has a dark spot defect according to an example embodiment of the present disclosure. FIG. 7 is a view illustrating light sensing signals detected when one of subpixels arranged in a column line of a display panel has a bright spot defect according to an example embodiment of the present disclosure.

First, as shown in FIG. 5 together with FIGS. 1 to 4, when all the subpixels SP arranged in a column line of the display panel 100 emit light normally, the light sensing signal SD of a normal current level can be generated through the photoresistor PR disposed in each of the subpixels SP and output to the sensing line SL.

In this case, as illustrated in FIG. 5, the light sensing signals SD applied to the sensing line SL during one frame can have a substantially constant normal level state. By checking the level state of this light sensing signals SD, it can be confirmed that all the subpixels SP are in a normal light emitting state.

Next, as shown in FIG. 6 together with FIGS. 1 to 4, when one of the subpixels SP arranged in the column line of the display panel 100 is defective in a dark spot DP and is abnormally non-luminous, a current does not substantially flow through the photoresistor PR disposed in the subpixel SP with the dark spot DP, so that a corresponding light sensing signal SD can have an off level.

In this case, as illustrated in FIG. 6, the light sensing signals SD applied to the sensing line (SL) during one frame can have an off level state during the sensing section for the row line where the subpixel SP with the dark spot DP is located. By checking the level state of the light sensing signals SD, the subpixel SP with the dark spot DP among the subpixels SP can be detected.

Next, as shown in FIG. 7 together with FIGS. 1 to 4, when one of the subpixels SP arranged in the column line of the display panel 100 is defective in a bright spot BP and emits abnormally bright light, an overcurrent higher than the normal current flows through the photoresistor PR disposed in the subpixel SP with the bright spot BP, so that a corresponding light sensing signal SD can have an over-level higher than the normal level.

In this case, as illustrated in FIG. 7, the light sensing signals SD applied to the sensing line SL during one frame has an over-level state during the sensing section for the row line where the subpixel SP with the bright spot BP is located. By checking the level state of the light sensing signals SD, the subpixel SP with the bright spot BP among the subpixels SP can be detected.

As such, by checking the state of the light sensing signal SD output to the sensing line SL, the light emitting state of each subpixel SP can be checked and the subpixel SP with the light emitting defect can be identified and detected.

As described above, according to this embodiment, the photoresistor PR that senses the light emitting state of the light emitting diode OD in the subpixel SP and generates the corresponding light sensing signal SD can be formed, and the light sensing signal SD of the subpixel SP can be output to the sensing line SD through the sensing transistor Ts in a unit of a row line.

Accordingly, by checking the state of the light sensing signal SD output to the sensing line SL, the light emitting state of each subpixel SP can be checked and the subpixel SP with the light emitting defect such as the dark spot or the bright spot can be specified and detected.

Therefore, the light emitting state of the light emitting diode (OD) can be easily identified and the light emitting defect can be effectively detected.

Hereinafter, an example of a structure of the light emitting display device that implements checking a light emitting state and detecting a light emitting defect according to this embodiment is described.

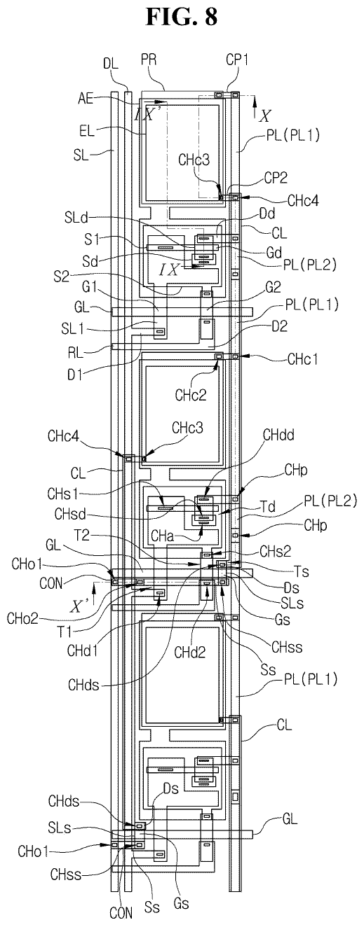

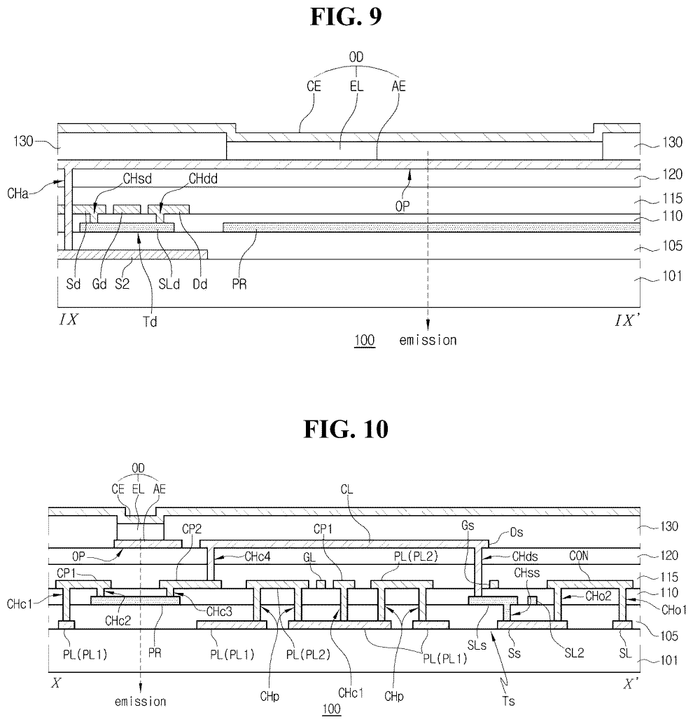

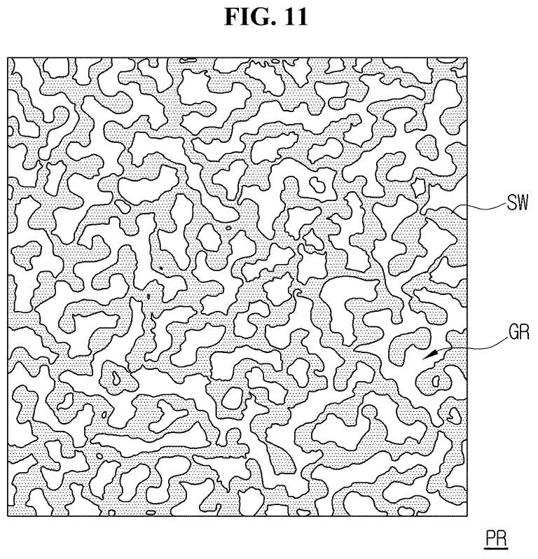

FIG. 8 is a plan view schematically illustrating subpixels of a light emitting display device according to an example embodiment of the present disclosure. FIG. 9 is a cross-sectional view taken along a line IX-IX′ in FIG. 8 and illustrates an example cross-sectional structure of a light emitting diode, a driving transistor, and a photoresistor of a subpixel. FIG. 10 is a cross-sectional view taken along a line X-X′ in FIG. 8 and illustrates an example cross-sectional structure of a sensing transistor and a photoresistor.

Prior to a specific description, in FIG. 8, for convenience of explanation, subpixels (SP: SP(1), SP(2) and SP(3)) located in three consecutive row lines in a column line, for example, a first row line, a second row line, and a third row line, are illustrated as an example.

As shown in FIGS. 1 to 7 and FIGS. 8 to 10, on the substrate 101 of the display panel 100 of this embodiment, the first and second transistors T1 and T2 and the driving transistor Td configured in a driving circuit region of the subpixel SP, and the light emitting diode OD located on the transistors T1, T2 and Td and configured in an emission region can be formed.

The light emitting diode OD can be configured, for example, in a bottom emission type. In this case, light can pass through an anode electrode AE of the light emitting diode OD and be emitted downward.

In each subpixel SP, the photoresistor PR can be formed that is formed below the light emitting diode OD and overlaps the emission region, and receives light emitted from the light emitting diode OD and output downward. The photoresistor PR can be formed to have substantially transparent characteristics to implement the downward emission from the light emitting diode OD.

In addition, the sensing transistor Ts connected between the photoresistor PR and the sensing line SL can be formed on the substrate 101.

The sensing transistor Ts can be disposed in the subpixel SP of a row line subsequent to a row line of the subpixel SP in which the photoresistor PR connected to the sensing transistor Ts is disposed. For example, the sensing transistor Ts connected to the photoresistor PR of the subpixel SP of a n-th row line can be disposed in the subpixel SP of a (n+1)-th row line.

The substrate 101 can use, for example, a glass substrate or a plastic substrate having insulating property. As another example, the substrate 101 can use a silicon wafer. In this embodiment, for convenience of explanations, the case where the substrate 101 is formed of a glass substrate or a plastic substrate is taken as an example.

The first transistor T1 can include a source electrode (or first source electrode) S1 and a drain electrode (or first drain electrode) D1, a gate electrode (or first gate electrode) G1, and a semiconductor layer (or first semiconductor layer) SL1.

The second transistor T2 can include a source electrode (or second source electrode) S2 and a drain electrode (or second drain electrode) D2, a gate electrode (or second gate electrode) G2, and a semiconductor layer (or second semiconductor layer) SL2.

The driving transistor Td can include a source electrode (or third source electrode) Sd and a drain electrode (or third drain electrode) Dd, a gate electrode (or third gate electrode) Gd, and a semiconductor layer (or third semiconductor layer) SLd.

The sensing transistor Ts can include a source electrode (or fourth source electrode) Ss, a drain electrode (or fourth drain electrode) Ds, a gate electrode (or fourth gate electrode) Gs, and a semiconductor layer (or fourth semiconductor layer) SLs.

For example, regarding the stacked structure of the transistors T1, T2, Td and Ts, the drain electrode D1 of the first transistor T1 and the source electrode S2 of the second transistor T2 can be formed on the substrate 101, and a buffer layer 105 formed of an insulating material can be formed on such the electrodes D1 and S2. Meanwhile, the data line DL can be formed at the same layer as such the electrodes D1 and S2. In addition, a first line PL1, which is part of the power line PL, can be formed at the same layer as such the electrodes D1 and S2.

The buffer layer 105 can be formed of, for example, an inorganic insulating material such as silicon oxide (SiO2) or silicon nitride (SiNx), but not limited thereto.

On the buffer layer 105, the semiconductor layers SL1, SL2, SLd, and SLs of the first and second transistors T1 and T2, the driving transistor Td, and the sensing transistor Ts can be formed. Each of such the semiconductor layers SL1, SL2, SLd, and SLs can include a channel region in the middle and source and drain regions on both sides thereof.

Furthermore, the photoresistor PR can be formed of the same material as and at the same layer as the semiconductor layers SL1, SL2, SLd, and SLs), but not limited thereto.

The semiconductor layers SL1, SL2, SLd, and SLs and the photoresistor PR can be formed of, for example, polycrystalline silicon, amorphous silicon, or an oxide semiconductor. In this embodiment, the case where the semiconductor layers SL1, SL2, SLd, and SLs and the photoresistor PR are formed of an oxide semiconductor, for example, IGZO, is taken as an example.

The oxide semiconductor is a photoelectric material that generate electron-hole pairs by photoelectric effect when exposed to light. Accordingly, since the photoresistor PR is formed of the oxide semiconductor, it is possible to receive light produced from the light emitting diode OD and generate a corresponding current, the light sensing signal SD.

A gate insulating layer 110 can be formed on the semiconductor layers SL1, SL2, SLd, and SLs and the photoresistor PR. The gate insulating layer 110 can be formed of an inorganic insulating material such as silicon oxide (SiO2) or silicon nitride (SiNx), but not limited thereto.

On the gate insulating layer 110, the gate electrodes G1, G2, Gd, and Gs of the first and second transistors T1 and T2, the driving transistor Td, and the sensing transistor Ts can be formed. In addition, the source electrode S1 of the first transistor T1, the drain electrode D2 of the second transistor T2, and the source electrode Sd and the drain electrode Dd of the driving transistor Td can be formed at the same layer as the gate electrodes G1, G2, Gd, and Gs. Meanwhile, the gate line GL can be formed at the same layer as the gate electrodes G1, G2, Gd, and Gs. In addition, the reference line RL, and a second line PL2 which is a part of and the power line PL can be formed at the same layer as the gate electrodes G1, G2, Gd, and Gs.

The source electrode S1 of the first transistor T1 and the gate electrode Gd of the driving transistor Td can be formed integrally.

The power line PL can include the first line PL1 and the second line PL2 that are connected to each other, and the first line PL1 can be formed to cross the gate line GL. The second line PL2 can be, for example, in contact with the first lines PL1 therebelow through contact holes CHp to be connected to the first lines PL1, and such the contact hole CHp can be formed in the buffer layer 105 and the gate insulating layer 110.

In addition, the drain electrode D1 of the first transistor T1 can be, for example, in contact with the drain region of the corresponding semiconductor layer SL1 through a contact hole CHd1 formed in the buffer layer 105.

The source electrode S2 of the second transistor T2 can be, for example, in contact with the source region of the corresponding semiconductor layer SL2 through a contact hole CHs2 formed in the buffer layer 105. The drain electrode D2 of the second transistor T2 can be, for example, in contact with the drain region of the corresponding semiconductor layer SL2 through a contact hole CHd2 formed in the gate insulating layer 115.

The source electrode S1 of the first transistor T1 can be, for example, in contact with the source region of the corresponding semiconductor layer SL1 through a contact hole CHs1 formed in the gate insulating layer 110. The source electrode Sd and the drain electrode Dd of the driving transistor Td can be, for example, in contact with the source region and the drain region of the corresponding semiconductor layer SLd through respective contact holes CHsd and CHdd formed in the gate insulating layer 110.

The drain electrode Dd of the driving transistor Td can be formed integrally with, for example, the second line PL2 of the power line PL.

Meanwhile, the source electrode Ss of the sensing transistor Ts can be, for example, in contact with the source region of the corresponding semiconductor layer SLs through a contact hole CHss formed in the buffer layer 105 or the gate insulating layer 110.

In this regard, in this embodiment, the case in which the source electrodes Ss of the sensing transistors Ts are formed at different layers according to the row lines is taken as an example. For example, the source electrode Ss of the sensing transistor Ts located in the second row line can be formed at the same layer as the data line DL, and in this case, this source electrode Ss can contact the corresponding semiconductor layer SLs through the contact hole CHss formed in the buffer layer 105. In addition, the source electrode Ss of the sensing transistor Ts located in the third row line can be formed at the same layer as the gate line GL, and in this case, this source electrode Ss can contact the corresponding semiconductor layer SLs through the contact hole CHss formed in the gate insulating layer 110. As such, the stacked positions of the source electrodes Ts of the sensing transistors Ts can alternate along the column line. Alternatively, the source electrodes Ss of the sensing transistors Ts arranged along the column line can be formed at the same layer.

Meanwhile, in this embodiment, the case where the planar positions of the sensing transistors Ts are different according to the row lines is taken as an example. As shown in FIG. 8, for example, the sensing transistor Ts in the second row line can be located on the right side, where the power line PL is located, of the corresponding subpixel (SP), and the sensing transistor Ts in the third row line can be located on the left side, where the data line DL is located, of the corresponding subpixel SP. As such, the positions of the sensing transistors Ts can alternate along the column line. Alternatively, the sensing transistors Ts arranged in the column line can be positioned in the same direction.

Meanwhile, for example, a connection pattern CON connecting the source electrode Ss of the sensing transistor Ts and the sensing line SL can be formed at the same layer as the gate electrodes G1, G2, Gd, and Gs.

For example, the connection pattern CON connected to the source electrode Ss of the sensing transistor Ts in the second row line can have one end, which is in contact with the sensing line SL through a contact hole CHo1 formed in the gate insulating layer 110 and the buffer layer 105, and the other end which is in contact with the source electrode Ss of the sensing transistor Ts through a contact hole CHo2 formed in the gate insulating layer 110 and the buffer layer 105. In addition, the connection pattern CON connected to the source electrode Ss of the sensing transistor Ts in the third row line can be formed integrally with this source electrode Ss, and can have one end which in contact with the sensing line SL through a contact hole CHo1 formed in the gate insulating layer 110 and the buffer layer 105.

Meanwhile, for example, a first contact pattern CP1 and a second contact pattern CP2 can be formed at the same layer as the gate electrodes G1, G2, Gd, and Gs.

The first contact pattern CP1 can connect, for example, the power line PL (for example, the first line PL1 of the power line PL) and the photoresistor PR, and accordingly, the high potential voltage VDD can be input to the photoresistor PR from the power line PL. One end of the first contact pattern CP1 can be, for example, in contact with the first line PL1 of the power line PL through a contact hole CHc1 formed in the buffer layer 105 and the gate insulating layer 110, and the other end of the first contact pattern CP1 can be, for example, in contact with the photoresistor PR through a contact hole CHc2 formed in the gate insulating layer 110.

The second contact pattern CP2 can be, for example, in contact with the photoresistor PR and a connection line CL, and accordingly, the light sensing signal SD generated in the photoresistor PR can be output to the connection line CL. One end of the second contact pattern CP2 can, for example, be in contact with the photoresistor PR through a contact hole CHc3 formed in the gate insulating layer 110, and the other end of the second contact pattern CP2 can be, for example, in contact with the connection line CL through a contact hole CHc4 formed in a passivation layer 115 and a planarization layer 120 which are on the second contact pattern CP2.

At least one insulating layer can be formed on the transistors T1, T2, Td, and Ts configured as described above. In this embodiment, the case where the passivation layer 115 and the planarization layer 120 can be formed on the transistors T1, T2, Td, and Ts is taken as an example.

The passivation layer 115 can be formed of, for example, an inorganic insulating material such as silicon oxide (SiO2) or silicon nitride (SiNx), or an organic insulating material such as photo acrylic or benzocyclobutene. The planarization layer 120 can be formed of, for example, an inorganic insulating material such as silicon oxide (SiO2) or silicon nitride (SiNx), or an organic insulating material such as photo acrylic or benzocyclobutene.

On the planarization layer 120, the anode electrode AE can be formed for each subpixel SP. When the bottom emission type light emitting display device 10 is used, the anode electrode AE can include a transparent conductive layer formed of, for example, a transparent conductive material such as ITO or IZO.

The anode electrode AE can be, for example, in contact with the source electrode Sd of the driving transistor Td through a contact hole CHa formed in the planarization layer 120 and the passivation layer 115. Furthermore, this contact hole CHa can penetrate the source electrode Sd of the driving transistor Td and be formed in the gate insulating layer 110 and the buffer layer 105, and through the contact hole CHa formed in this way, the anode electrode AE can contact the source electrode Sd of the driving transistor Td and the source electrode S2 of the second transistor T2.

Meanwhile, the connection line CL connecting the photoresistor PR and the corresponding sensing transistor Ts can be formed, for example, at the same layer as the anode electrode AE.

In this regard, one end (or first end) of the connection line CL can be connected to the second contact pattern CP2 connected to the photoresistor PR, and the other end (or second end) of the connection line CL can be connected to the drain electrode Ds of the sensing transistor Ts. For example, as mentioned above, one end of the connection line CL can be in contact with the second contact pattern CP2 through the contact hole CHc4 formed in the planarization layer 120 and the passivation layer 115. In addition, the drain electrode Ds of the sensing transistor Ts can be formed integrally with the connection line CL, and in this case, this drain electrode Ds can, for example, be in contact with the drain region of the corresponding semiconductor layer SLs through the contact hole CHds formed in the planarization layer 120, the passivation layer 115, and the gate insulating layer 110.

In this embodiment, similar to the positions of the sensing transistors Ts mentioned above, the case where the planar positions of the connection lines CL are formed differently according to the row lines is taken as an example. In this regard, as shown in FIG. 8, for example, the connection line CL connected to the sensing transistor Ts of the second row line can be positioned to overlap the power line PL on the right side where the power line PL is located, and the connection line CL connected to the sensing transistor Ts of the third row line can be positioned on the left side where the data line DL is located. As such, the positions of the connection lines CL connected to the sensing transistors Ts along the column line can alternate. Alternatively, the connection lines CL arranged along the column line can be positioned in the same direction.

On the planarization layer 120 and the anode electrode AE, a bank 130 can be formed along a boundary of each subpixel SP. The bank 130 can include an opening OP that exposes the anode electrode AE, and the bank 130 can cover an edge of the anode electrode AE. The opening OP of the bank 130 can define the emission region of the subpixel SP. In this case, a region, where the bank 130 is formed, in the subpixel SP can be considered as a non-emission region.

A light emitting layer EL can be formed on the anode electrode AE. The light emitting layer EL can include a light emitting material (e.g., organic light-emitting material) that produces a color light of its subpixel SP or emits white light.

A cathode electrode CE can be formed on the light emitting layer EL. For example, the cathode electrode CE can be formed in a continuous form across the entire display region AA to correspond to all subpixels SP.

When the bottom emission type light emitting display device 10 is used, the cathode electrode CE can include, for example, a reflective layer formed of a metal with high reflective characteristics, such as Ag.

As above, in each subpixel SP, the light emitting diode OD configured with the anode electrode AE, the light emitting layer EL, and the cathode electrode CE can be formed in the emission region.

In the structure as above, when the light emitting diode OD of the subpixel SP emits light, the corresponding photoresistor PR can receive the light, and the light sensing signal SD corresponding to the amount of the received light can be generated, and this light sensing signal SD can be output to the sensing line SL through the sensing transistor Ts connected to the photoresistor PR.

Meanwhile, since the photoresistor PR of this embodiment is positioned in the emission direction corresponding to the light emitting diode OD, the photoresistor PR can be formed in a maze structure (or mesh structure) to secure sufficient light output by reducing light loss due to the photoresistor PR, which is described with further reference to FIG. 11. FIG. 11 is a plan view schematically illustrating a case where a photoresistor of a display panel is formed in a maze structure according to an example embodiment of the present disclosure.

As shown in FIG. 11, the photoresistor PR formed of a photoelectric material can be formed as an irregularly shaped maze structure. For example, when viewed in plan, the photoresistor PR can be configured with a plurality of grooves (or maze grooves) GR of irregular shapes rather than linear shapes, and partition walls SW surrounding the plurality of grooves GR.

In this regard, the partition walls SW formed of the photoelectric material can substantially function as the photoresistor PR, and can have a substantially continuous and overall connected form within the photoresistor PR so as to transmit a current generated by a photoelectric effect.

In addition, the plurality of grooves GR defined by the partition walls SW can substantially serve as openings, example, can expose the buffer layer 105 which is a layer formed therebelow. The grooves GR can be arranged in a dispersed manner within the photoresistor PR, and more preferably, they can be irregularly dispersed.

In addition, the plurality of grooves GR can have irregular shapes, and furthermore, the shapes of the plurality of grooves GR can be different from each other. An area occupied by the plurality of grooves GR of the photoresistor (PR) can be, for example, more than 0% and less than 50% of a total area of the photoresistor PR, but not limited thereto.

As such, the photoresistor PR can have the irregularly shaped maze structure in which the grooves GR are dispersed, so that the loss of light passing through the photoresistor PR can be reduced. In addition, the irregular shape of the photoresistor GR can cause a scattering effect on light passing through it, and thus a light efficiency can be improved.

As described above, according to the embodiment of the present disclosure, the photoresistor that senses the light emitting state of the light emitting diode in the subpixel and generates the corresponding light sensing signal can be formed, and the light sensing signal generated in this way can be output to the sensing line in a unit of a row line through the sensing transistor.

Accordingly, by checking the state of the light sensing signal output to the sensing line, the light emitting state of each subpixel can be checked, and the subpixel with a light emitting defect such as a dark spot or a bright spot can be specified and detected.

Therefore, the light emitting state of the light emitting diode can be easily identified, and the light emitting defect can be effectively detected.

Since the light emitting state of the light emitting diode can be easily identified in this way, light emitting defect information can be identified not only by a manufacturer but also after delivery to the customer, and can be effectively used for product development and quality improvement.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A light emitting display device, comprising:
a substrate including a display region in which a plurality of subpixels are arranged;
a light emitting diode in a subpixel, among the plurality of subpixels, and including an anode electrode, a light emitting layer on the anode electrode, and a cathode electrode on the light emitting layer;
a photoresistor in the subpixel and positioned below the light emitting diode;
a sensing transistor having a drain electrode connected to the photoresistor and a gate electrode connected to a gate line; and
a sensing line connected to a source electrode of the sensing transistor.

2. The light emitting display device of claim 1, wherein the photoresistor includes a photoelectric material.

3. The light emitting display device of claim 2, wherein the photoelectric material is an oxide semiconductor.

4. The light emitting display device of claim 1, wherein the sensing transistor is disposed in another subpixel of a row line subsequent to a row line of the subpixel where the photoresistor is disposed, among the plurality of subpixels, the sensing transistor being connected to the gate line of the subsequent row line.

5. The light emitting display device of claim 1, wherein the photoresistor is connected to a power line that transmits a high potential voltage.

6. The light emitting display device of claim 5, further comprising a connection line connecting the photoresistor to the sensing transistor,
wherein the connection line is formed at the same layer as the anode electrode.

7. The light emitting display device of claim 6, further comprising a first contact pattern and a second contact pattern formed at the same layer as the gate line,
wherein the first contact pattern is in contact with the power line and the photoresistor, and the second contact pattern is in contact with the connection line and the photoresistor.

8. The light emitting display device of claim 1, wherein the photoresistor and a semiconductor layer of the sensing transistor are formed of an oxide semiconductor at the same layer.

9. The light emitting display device of claim 1, wherein the photoresistor has an irregularly shaped maze structure.

10. The light emitting display device of claim 9, wherein the photoresistor includes a plurality of grooves having irregular shapes and arranged in a dispersed manner within the photoresistor.

11. The light emitting display device of claim 10, wherein an area occupied by the plurality of grooves is greater than 0% and less than 50% of a total area of the photoresistor.

12. A light emitting display device, comprising:
a substrate including a display region in which a plurality of subpixels are arranged;
a plurality of light emitting diodes, each light emitting diode being disposed in a respective subpixel, among the plurality of subpixels, and including an anode electrode, a light emitting layer on the anode electrode, and a cathode electrode on the light emitting layer;
a plurality of photoresistors, each photoresistor overlapping an emission region of the respective subpixel and positioned in an emission direction of a light emitting diode disposed in the respective subpixel;
a sensing line receiving light sensing signals respectively generated by the plurality of photoresistors; and
a plurality of sensing transistors each connecting a respective photoresistor among the plurality of photoresistors to the sensing line,
wherein the light sensing signals for the plurality of subpixels are sequentially output to the sensing line in a unit of a row line through the plurality of sensing transistors.

13. The light emitting display device of claim 12, wherein the plurality of photoresistors include oxide semiconductors.

14. The light emitting display device of claim 12, wherein the plurality of photoresistors receive a high potential voltage.

15. The light emitting display device of claim 12, wherein each of the plurality of photoresistors includes a plurality of grooves having irregular shapes and arranged in a disposed manner within the photoresistor.

16. The light emitting display device of claim 12, wherein each sensing transistor is disposed in a subpixel of a row line subsequent to a row line of a subpixel where the respective photoresistor is disposed, and is connected to a gate line of the subsequent row line.

17. A light emitting display device comprising a display region in which a plurality of subpixels are arranged along a plurality of row lines and a plurality of column lines, each of the plurality of subpixels including:
a first transistor;
a light emitting diode;
a driving transistor having a first electrode connected to a power line of high potential voltage, a second electrode connected to an anode electrode of the light emitting diode, and a gate electrode coupled to the first transistor;
a second transistor coupled to the second electrode of the driving transistor; and
a photoresistor connected to the power line of high potential voltage.

18. The light emitting display device of claim 17, further comprising a plurality of sensing transistors each disposed in a subpixel of a row line subsequent to a row line of the subpixel where the photoresistor is disposed, connected to a gate line of the subsequent row line, and configured to transmit a light sensing signal generated by the photoresistor to a sensing line.

19. The light emitting display device of claim 17, wherein each subpixel further includes a capacitor connected between the gate electrode and the first or second electrode of the driving transistor.

20. The light emitting display device of claim 17, wherein the photoresistor includes a photoelectric material.

21. The light emitting display device of claim 20, wherein the photoelectric material is an oxide semiconductor.

22. The light emitting display device of claim 17, wherein a cathode of the light emitting diode is connected to a power line of low potential voltage.
